(19) United States
(12) Patent Application Publication
(10) Pub. No.: US 2019/0179442 A1
(43) Pub. Date: Jun. 13, 2019

(54) TOUCH SENSOR MEMBER, TOUCH SENSOR AND DISPLAY PANEL UNIT

(71) Applicant: NIPPON ELECTRIC GLASS CO., LTD., Otsu-shi, Shiga (JP)

(72) Inventors: Shigeaki AOKI, Otsu-shi, Shiga (JP); Yoshiharu MIWA, Otsu-shi, Shiga (JP); Hiroyuki UCHIDA, Otsu-shi, Shiga (JP); Hiroaki TANAKA, Otsu-shi, Shiga (JP); Tai FUJISAWA, Otsu-shi, Shiga (JP); Seiji HAMADA, Otsu-shi, Shiga (JP)

(73) Assignee: NIPPON ELECTRIC GLASS CO., LTD., Otsu-shi, Shiga (JP)

(21) Appl. No.: 16/325,756

(22) PCT Filed: Aug. 17, 2017
(86) PCT No.: PCT/JP2017/029551

§ 371 Date: Feb. 15, 2019

(30) Foreign Application Priority Data
Aug. 19, 2016 (JP) 2016-161082

(51) Int. Cl. G06F 3/041

(52) U.S. Cl. CPC G06F 3/041

(57) ABSTRACT

A touch sensor member includes a base material and a sensor circuit wiring formed on the base material, the base material includes a glass film having a thickness of 300 μm or less, and the sensor circuit wiring includes a metal wire having a width of 25 μm or less.

### TECHNICAL FIELD

The present invention relates to a touch sensor member, a touch sensor and a display panel unit.

### BACKGROUND ART

A display panel unit in which a device operates by touching a display with a finger is widely used. In particular, as a device, a navigation device that displays a destination on the display and gives guidance to a driver of a vehicle is widely used.

For example, a display panel unit in Patent Document 1 is configured to be large and long in the vertical direction. A monitor display portion of the display panel unit is configured by a navigation screen of a navigation device, an audio operation screen of an audio device, and an air conditioner operation screen of an air conditioner device, and these screens are disposed such that the screens can be displayed at a time. The entire monitor display portion configuring these screens is a touch panel.

### RELATED ART DOCUMENT

### Patent Document

Patent Document 1: JP-A-2008-107238

### SUMMARY OF THE INVENTION

### Problems to be Solved by the Invention

The display panel unit disclosed in Patent Document 1 is configured to be large and long in the vertical direction in a state in which a plurality of operation screens are arranged in the vertical direction within a single plane. Therefore, for example, the air conditioner operation screen disposed at the lowermost position may be difficult to see or operate.

Therefore, if the display panel unit can be formed in a gentle concave shape, the above problem can be solved. However, since the touch panel generally has high rigidity, there are many restrictions on the design of the display panel unit, for example, it is difficult to configure the shape of the display panel unit having the touch panel into a curved shape.

The present invention has been made in view of the above circumstances, and an object of the present invention is to provide a touch sensor member with which a display panel unit can be easily formed into a curved shape, a touch sensor including the touch sensor member, and a display panel unit including the touch sensor.

### Means for Solving the Problems

A touch sensor member according to one aspect of the present invention includes a base material and a sensor circuit wiring formed on the base material, in which the base material includes a glass film having a thickness of 300 μm or less, and the sensor circuit wiring includes a metal wire having a width of 25 μm or less.

With such a configuration, the touch sensor member can be easily formed into various shapes such as a curved shape. Therefore, the touch sensor member can be easily formed into a curved shape even if the touch sensor member is relatively large. Furthermore, as compared with the case where the sensor circuit wiring includes an oxide transparent conductive film, the sensor circuit wiring is difficult to be peeled off from the base material and disconnected. Therefore, even if the touch sensor member is formed into a curved shape, it is unlikely that the sensor circuit wiring is peeled off from the base material or disconnected. As described above, even if the display panel unit is configured to be large and long in the vertical direction, it is possible to easily form the display panel unit into a curved shape, and it is possible to reduce design restrictions without decreasing visibility and operability.

Further, in the above touch sensor member, it is preferable that the touch sensor member includes a substantially rectangular base material and a plurality of sensor circuit wirings formed on the base material, the plurality of sensor circuit wirings are formed in a plurality of regions separated from each other on the base material, and a non-formation region of the sensor circuit wirings is formed in s strip shape across an entire length in a transverse direction or a longitudinal direction of the base material.

With such a configuration, the touch sensor member is more easily deformed into a curved shape in the non-formation region of the sensor circuit wiring in the touch sensor member. Therefore, even if the display panel unit using the touch sensor member is configured to be large and long in the vertical direction, it is possible to easily form the display panel unit into a curved shape, and it is possible to reduce design restrictions without decreasing visibility and operability.

A touch sensor of the present invention includes the touch sensor member described above and a touch operation surface member provided so as to cover the touch sensor member, wherein the touch operation surface member includes a glass film having a thickness of 300 μm or less.

With such a configuration, similar to the touch sensor member, the touch operation surface member can be easily formed into various shapes such as a curved shape. Therefore, even if the display panel unit using the touch sensor is configured to be large and long in the vertical direction, it is possible to easily form the display panel unit into a curved shape, and it is possible to reduce design restrictions without decreasing visibility and operability. In addition, since the touch sensor has high sensitivity, it is easy for the operator to operate the touch operation panel by bringing the finger close to the touch operation surface member.

In the touch sensor, it is preferable that the sensor circuit wiring is black on a touch operation surface member side.

With such a configuration, when the touch sensor is used for a display device, the contrast of the display screen is improved. In addition, a situation can be prevented in which electrodes are visually recognized by the operator on the display screen, or phenomena such as black floating of the image occur. That is, with such a configuration, the visibility of the display screen can be improved.

A display panel unit of the present invention, in which the touch sensor described above is included and the sensor circuit wiring is a circuit wiring for a touch panel, includes a display device positioned in a corresponding position of the circuit wiring for the touch panel and on an opposite side of the touch operation surface member.

With such a configuration, even if the display panel unit is configured to be large and long in the vertical direction, it is possible to easily form the display panel unit into a curved shape, and it is possible to reduce design restrictions without decreasing visibility and operability.

In the above display panel unit, it is preferable that the plurality of sensor circuit wirings is included, the sensor circuit wiring different from the touch panel circuit wiring is the circuit wiring for a touch switch, and a light emitting element is provided in a position corresponding to the circuit wiring for the touch switch and on an opposite side with respect to the touch operation surface member.

With such a configuration, it is possible to efficiently transmit the light of the light emitting element to the touch operation surface member side. Therefore, the visibility of the touch switch is improved.

In the display panel unit, it is preferable that the touch sensor including the circuit wiring for the touch switch is formed into a curved shape.

With such a configuration, the design property of the display panel unit is improved.

### Effect of the Invention

According to the present invention, it is possible to provide a touch sensor member with which a display panel unit can be formed into a curved shape, a touch sensor including the touch sensor member, and a display panel unit including the touch sensor.

### BRIEF DESCRIPTION OF DRAWINGS

FIG. 1 is a perspective view of a touch sensor member 1 according to a first embodiment.

FIG. 2 is an enlarged view of the circle X in FIG. 1.

FIG. 3 is a cross-sectional view of a touch sensor member 16 including a thin wire 3y according to the first embodiment.

FIG. 4 is a perspective view of a touch sensor member 11 according to a second embodiment.

FIG. 5 is a perspective view of the touch sensor member 16 according to a third embodiment.

FIG. 6 is a cross-sectional view of the touch sensor member 16 taken along line A-A according to the third embodiment.

FIG. 7 is a perspective view of a touch sensor 21 according to the first embodiment.

FIG. 8 is a cross-sectional view of the touch sensor 21 taken along line B-B according to the first embodiment.

FIG. 9 is a cross-sectional view of a touch sensor 26 according to the second embodiment.

FIG. 10 is a cross-sectional view of the touch sensor 26 taken along line C-C according to the second embodiment.

FIG. 11 is a perspective view of a display panel unit 31 according to the first embodiment.

FIG. 12 is an exploded view of a display panel unit 41 according to the second embodiment.

FIG. 13 is a perspective view of the display panel unit 41 according to the second embodiment.

FIG. 14 is an exploded view of a display panel unit 61 according to the third embodiment.

### DESCRIPTION OF EMBODIMENTS

Hereinafter, embodiments for carrying out the present invention will be described, but the present invention is not limited to the following embodiments, and various modifications may be made without departing from the scope of the present invention, it should be understood that those in which changes, improvements, and the like have been appropriately added to the following embodiments fall within the scope of the present invention.

(Touch Sensor Member)

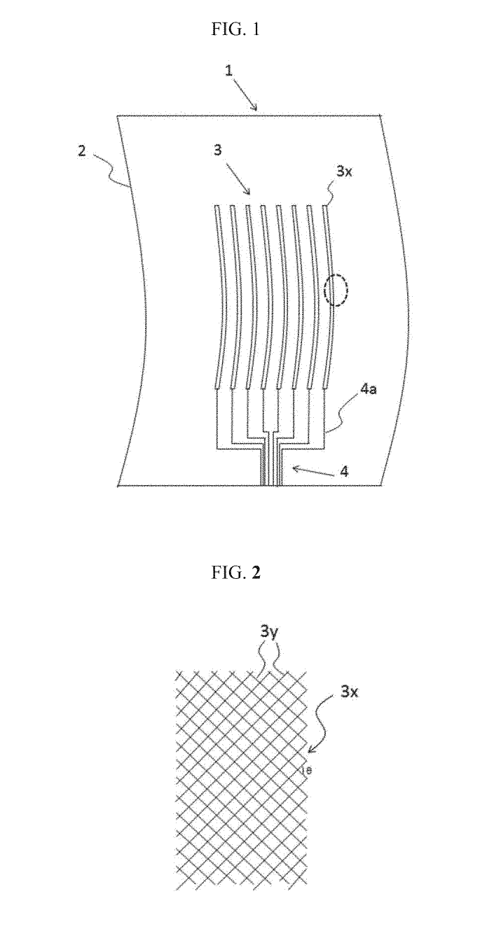

FIG. 1 is a perspective view of a touch sensor member 1 according to a first embodiment of the present invention.

The touch sensor member 1 includes as main components a base material 2 and a sensor circuit wiring 3 formed on the base material 2. The sensor circuit wiring 3 is used as a circuit wiring for a touch switch.

The base material 2 includes a glass film having a thickness of 300 μm or less. Since the glass film having a thickness of 300 μm or less has flexibility, the base material can easily be formed into various shapes such as a curved shape. Since the flexibility is higher as the thickness of the glass film is smaller, the thickness of the glass film is preferably 200 μm or less, more preferably 150 μm or less, further preferably 100 μm or less, and most preferably 50 μm or less. On the other hand, since the impact resistance is low when the thickness of the glass film is too small, the thickness of the glass film is preferably 5 μm or more, more preferably 10 μm or more, further preferably 20 μm or more, and most preferably 30 μm or more.

The material of the glass film is not particularly limited, and examples thereof include soda-lime glass, alkali-free glass, aluminosilicate glass, and the like. When the aluminosilicate glass is an alkali metal-containing aluminosilicate glass, the base material 2 may be a chemically strengthened glass film.

Although the shape of the base material is not particularly limited, in the present embodiment, the shape of the base material 2 is rectangular. Alternatively, the base material 2 may be, for example, a substantially rectangular shape obtained by round processing of corner portions.

The sensor circuit wiring 3 has a plurality of thick wires 3x extending in a vertical direction in FIG. 1. Further, as shown in FIG. 2, each thick wire 3 includes a plurality of thin wires 3y formed at equal intervals in parallel and a plurality of thin wires 3y which intersect the thin wires 3y at a predetermined angle θ (θ=90° in FIG. 2) and are formed at equal intervals in parallel. That is, the thick wire 3x includes thin wires 3y formed in a lattice pattern. These thin wires 3y are so-called metal wires made of metal, and the width thereof is 25 μm or less. Further, at the intersection of the thin wires 3y, two thin wires 3y are connected to each other and electrically connected.

The metal wire has lower electric resistance than, for example, an oxide transparent conductive film (ITO, FTO, and the like). Therefore, even when the width of the metal wire is set to 25 μm or less, sufficient energization is possible. In addition, such a thin metal wire is excellent in flexibility. Therefore, as shown in FIG. 1, the touch sensor member 1 can be formed into a curved shape, and it is unlikely that the sensor circuit wiring 3 will be disconnected or peeled off from the base material 2 even if the base material is formed into a curved shape.

The width of the metal wire is preferably 20 μm or less, more preferably 15 μm or less, further preferably 10 μm or less, and most preferably 5 μm or less. By adopting the width as described above, when the touch sensor member 1 according to the present embodiment is used for a display panel unit, the visibility of the screen is improved.

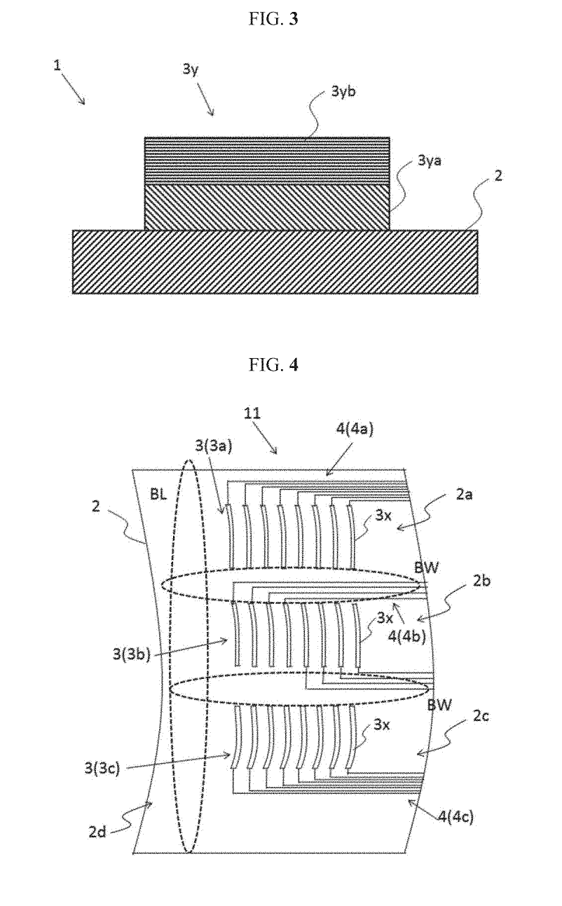

As shown in FIG. 3, the thin wire 3y includes a metallic luster layer 3ya having a metallic luster formed on the base material 2, and a blackened layer 3yb which does not have metallic luster formed on the metallic luster layer 3ya and has a black appearance. Such a sensor circuit wiring 3 is black when viewed from the opposite side (an upper side in FIG. 3) with respect to the base material 2.

The metallic luster layer 3ya is not particularly limited, but the metallic luster layer is made of metal such as copper, nickel, gold and the like. Copper or nickel is preferable from the viewpoint of a metal material available for fine etching. Copper has low electric resistance, and good film uniformity in electroless plating. In addition, since nickel has a lower reflectance than copper, nickel exhibits a dark black color when viewed from the opposite side with respect to the base material 2.

The thickness of the metal wire (in FIG. 3, the sum of the thicknesses of the metallic luster layer 3ya and the blackened layer 3yb) is preferably 20 μm or less, more preferably 10 μm or less, and most preferably 5 μm or less. By adopting the above thickness, the metal wire is more excellent in flexibility. Further, the thickness of the metal wire is preferably 0.1 μm or more, more preferably 0.5 μm or more, and most preferably 1 μm or more. By setting the above thickness, energization can be achieved.

By being black, when the touch sensor member 1 according to the present embodiment is used for a display panel unit, the contrast of the screen is improved. In addition, it is possible to prevent that the electrode is visually recognized by the operator and the phenomena such as black floating of the image occur. Therefore, the visibility of the screen can be improved.

The sensor circuit wiring 3 can be formed by, for example, the following method.

First, a metal film is formed on the base material 2. The metal film can be formed on the base material 2 by, for example, plating treatment, such as electroless plating treatment, electroplating treatment, and the like, sputtering, vacuum vapor deposition, and the like. Further, the metal film may be formed by attaching a metal foil on the base material 2.

Next, a black layer is formed on the metal layer by, for example, black plating treatment.

Finally, the metal film and the black layer are etched. First, the surface of the metal film was ultrasonically cleaned with acetone and the like and dried. Next, a photoresist was spin-coated on the surface of the metal film. After coating the photoresist, pre-baking was carried out at about 100° C. Next, mask pattern exposure was carried out with an exposure machine. Development was carried out using, for example, a TMAH alkaline solution of NMD-3 manufactured by TOKYO OHKA KOGYO CO., LTD. Then, the alkaline solution is washed with water, post-baked at about 120° C. after drying, and a resist pattern as an etching mask is completed.

The etching can be carried out, for example, with an aqueous solution containing an acid such as an inorganic acid or an organic acid and an oxidizing agent such as hydrogen peroxide. The base material 2 having the metal film and the resist pattern formed thereon was immersed in the solution and etching was carried out.

The sensor circuit wiring 3 has a lead wire 4 as shown in FIG. 1. The lead wire 4 is formed on the base material 2 in order to transmit a signal generated in the thick wires 3x of the sensor circuit wiring 3 to a central processing unit (CPU) (not shown). The lead wire 4 includes the same number of lead thin wires 4a as the thick wires 3x and extends to the vicinity of an edge side of the base material 2. Each thick wire 3x is connected to the CPU via the lead thin wire 4a. The lead wire 4 is made of the same material as the thin wire 3y of the sensor circuit wiring 3, for example. When the width of the lead wire 4 is thicker than the thin wire 3y of the sensor circuit wiring 3, disconnection of the lead wire 4 is prevented. Therefore, an increase in electric resistance caused by disconnection of the lead wire 4 can be prevented which is preferable. The width of the lead wire 4 is preferably 10 μm or more, more preferably 20 μm or more.

FIG. 4 is a perspective view of a touch sensor member 11 according to a second embodiment of the present invention. The same parts as those of the first embodiment described above will not be described.

The touch sensor member 11 has three sensor circuit wirings 3 (3a, 3b, 3c). Further, sensor circuit wirings 3 has lead wires 4 (4a, 4b, 4c) respectively.

As shown in FIG. 4, the sensor circuit wirings 3a, 3b, 3c are formed on the base material 2 so as to be separated from each other in a longitudinal direction direction (vertical direction in FIG. 3).

In order to transmit signals generated in the thick wires 3x of the sensor circuit wirings 3a, 3b, 3c to the CPU (not shown), the lead wires 4a, 4b, 4c are formed on the base material 2, respectively.

Further, since the sensor circuit wirings 3a, 3b, 3c are respectively formed in the three regions 2a, 2b, 2c separated from each other on one substrate 3, as shown in FIG. 4, a transverse direction non-formation region BW of the sensor circuit wiring extending in the transverse direction (horizotal direction in FIG. 4) is formed. Further, in the region 2d on the left side of the base material 2, a longitudinal direction non-formation region BL of the sensor circuit wiring extending in a longitudinal direction (vertical direction in FIG. 4) is formed.

Since there are no sensor circuit wirings 3a, 3b, 3c including the metal wire (thin wire y) in the longitudinal direction non-formation region BL of the sensor circuit wiring and the transverse direction non-formation region BW of the sensor circuit wiring, the touch sensor member 11 can be easily deform into a curved shape in the longitudinal direction non-formation region BL of the sensor circuit wiring or the transverse direction non-formation region BW of the sensor circuit wiring. Further, when the longitudinal direction non-formation region BL of the sensor circuit wiring or the transverse direction non-formation region BW of the sensor circuit wiring is greatly deformed, and deformation in the regions 2a, 2b, 2c where the sensor circuit wirings 3a, 3b, 3c are formed is small, it is difficult for bending stress to be applied to the metal wire, so that the sensor circuit wirings 3a, 3b, 3c are peeled from the base material 2 with difficultly, which is preferable.

Incidentally, the lead wire 4 can be disposed in the longitudinal direction non-formation region BL and the transverse direction non-formation region BW. Further, the lead wires 4a, 4b, 4c from the sensor circuit wirings 3a, 3b, 3c are disposed close to each other so as to extend to the vicinity of the end side of an arbitrary side of the base material 2 (the right side of the page in FIG. 4), so that it is possible to facilitate transmission to the CPU.

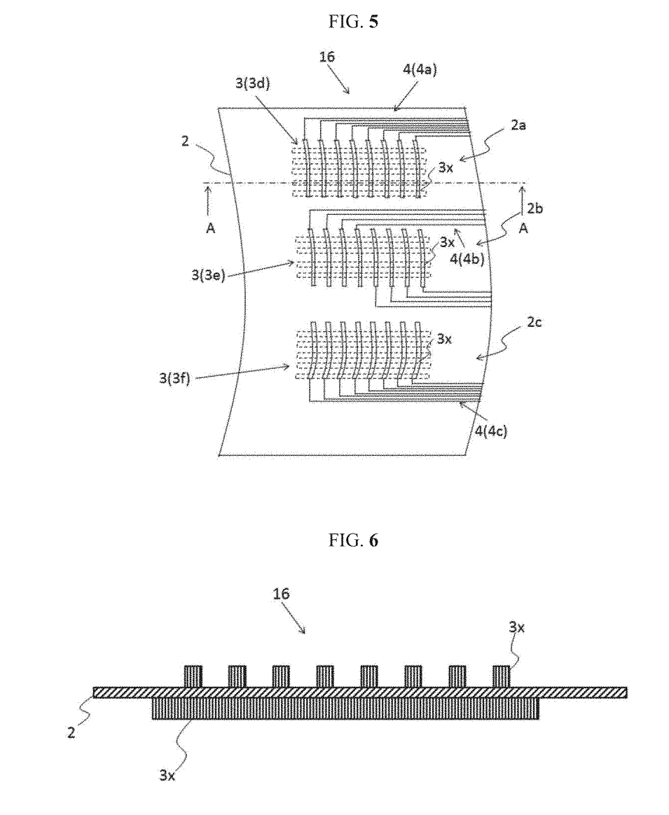

FIG. 5 is a perspective view of the touch sensor member 11 according to a third embodiment of the present invention. The same parts as those of the second embodiment described above will not be described.

In the touch sensor member 16 according to the third embodiment, similarly to the touch sensor member 11 according to the second embodiment, three sensor circuit wirings are formed in three regions 2a, 2b, 2c separated from each other on one base material 2 in the longitudinal direction, respectively. The difference from the touch sensor member 11 according to the second embodiment is the configuration of the sensor circuit wiring 3. The thick wire 3x of the touch sensor member 11 according to the second embodiment is formed only on one side of the base material 2 and extends in the vertical direction in FIG. 4, but the touch sensor member according to the third embodiment, as shown in FIGS. 5 and 6, the thick wires 3x of the touch sensor member 16 are formed on both sides of the base material 2, the thick wire 3x formed on one side extends in the vertical direction in FIG. 5, and the thick wire 3x formed on the other side extends in the horizontal direction in FIG. 5. Incidentally, in FIG. 6, each thick wire 3x includes a plurality of thin wires 3y formed in a grid pattern as shown in FIG. 2, but all the thick wires 3x described below are omitted for the sake of convenience in a rectangular cross section.

Incidentally, in the touch sensor member 16 according to the third embodiment, the thick wires 3x including the sensor circuit wirings 3d, 3e, 3f are formed on both sides of the base material 2, for example, in any one or two of the two sensor circuit wirings, the thick wire 3x may be formed only on one side.

Next, a touch sensor member according to a fourth embodiment will be described. The same parts as those of the second embodiment described above will not be described.

In the touch sensor member according to the fourth embodiment, similarly to the touch sensor member 11 according to the second embodiment, three sensor circuit wirings are formed in three regions 2a, 2b, 2c separated from each other on one base material 2 in the longitudinal direction, respectively. The difference from the touch sensor member 11 according to the second embodiment is the configuration of thin wires. The thin wire 3y of the touch sensor member 11 according to the second embodiment is black when viewed from the opposite side with respect to the base material 2, and the touch sensor member according to the fourth embodiment is also black when viewed from the side of the base material 2.

The sensor circuit wiring 3 of the touch sensor member according to the fourth embodiment can be formed by the following method.

First, the base material 2 is immersed in a solution containing one or more of tin, zinc, and copper, the metal ions are adsorbed on the surface of the base material 2, and then the base material 2 is immersed in an aqueous solution containing noble metal such as platinum. Thus, metal ions such as tin, zinc, copper and the like adsorbed on the surface of the base material 2 are replaced with noble metal ions due to a difference in ionization tendency, and a film mainly containing noble metal or a noble metal compound on the surface of the base material 2 is formed. Then, the base material 2 on which the film is formed is immersed in a reducing solution. Accordingly, the noble metal in the vicinity of the surface of the film is reduced to a state having catalytic action of electroless plating.

Next, a metal film is formed on the base material 2 by electrolytic plating or electroless plating. The metal film is not particularly limited, but examples thereof include copper, nickel, gold and the like. Copper or nickel is preferable from the viewpoint of a metal material capable of fine etching. Copper has low electric resistance, and good film uniformity in electroless plating. In addition, nickel has the merit that the reflectance is lower (black) than copper.

Finally, the metal film is etched. The etching can be carried out in the same manner as described in the first embodiment.

The sensor circuit wiring 3 formed in this way includes a blacken layer formed on the base material 2 and a metallic luster film on the blacken layer, and is black when viewed from the side of the base material 2. The reason why the blackened layer is formed on the base material 2 is not clear, but it is considered that the noble metal reacts with the metal and blackening is carried out. By being black, when the touch sensor member 1 according to the present embodiment is used for the display panel unit, the contrast of the screen is improved. In addition, it is possible to prevent a situation where the electrode is visually recognized by the operator and the occurrence of the phenomena such as black floating of the image. Therefore, the visibility of the screen can be improved.

Incidentally, in addition to the above method, for example, the metal film may be formed on the base material 2 by sputtering, vacuum deposition, and the like. Further, the metal film may be formed by attaching a metal foil on the base material 2.

(Touch Sensor)

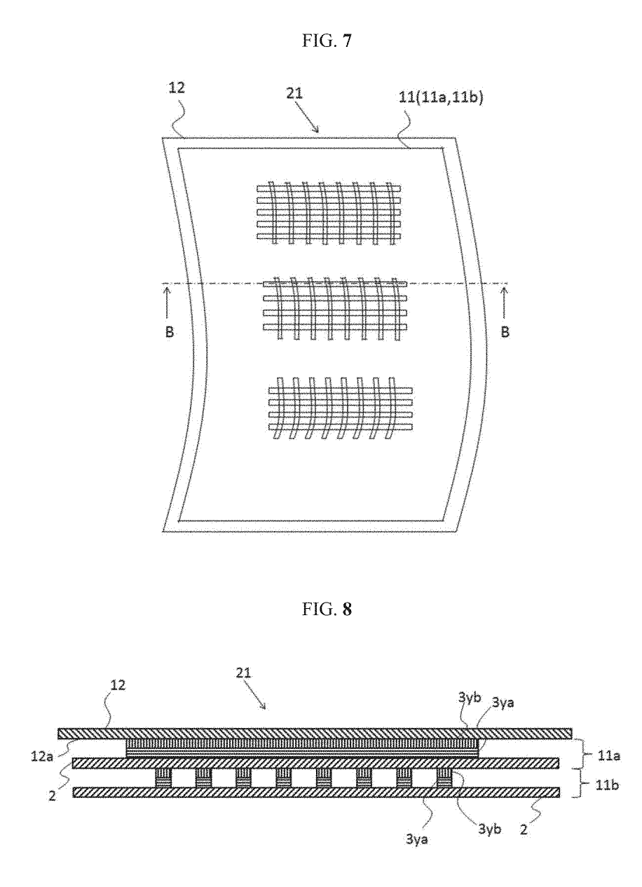

FIG. 7 is a perspective view of a touch sensor 21 according to a first embodiment of the present invention.

The touch sensor 21 is used as a touch panel, and includes as main components the touch sensor member 11 (11a, 11 b) of the second embodiment and a touch operation surface member 12. Incidentally, in FIG. 7, the lead wire 4 is omitted for the sake of simplicity.

The touch operation surface member 12 includes a glass film having a thickness of 300 μm or less. For example, the touch operation surface member can include a glass film having the same material and thickness as the base material 2 described above. Since the glass film having a thickness of 300 μm or less has flexibility, the touch operation surface member can be easily formed into various shapes such as a curved shape, and the sensitivity of the touch panel can be increased. Incidentally, since the flexibility and the sensitivity when used as a touch panel is higher as the thickness of the glass film is smaller, the thickness of the glass film is preferably 200 μm or less, more preferably 150 μm or less, further preferably 100 μm or less, and most preferably 50 μm or less. On the other hand, since the impact resistance is low when the thickness of the glass film is too small, the thickness of the glass film is preferably 1 μm or more, more preferably 5 μm or more, further preferably 10 μm or more, and most preferably 20 μm or more.

Incidentally, the size of the touch operation surface member 12 may be the same width and length as the base material 2 and may be larger and longer than the base material 2 as shown in FIG. 7.

As shown in FIG. 8, the touch sensor member 11a is formed on one main surface 12a of the touch operation surface member 12. Incidentally, in FIG. 7, the touch operation surface member 12 is disposed on a front side when viewed on a paper, and the touch sensor member 11a is disposed on the back side when viewed on a paper. The touch sensor member 11a is bonded to the touch operation surface member 12 via a transparent optical adhesive film and the like (not shown). As described above, the sensor circuit wiring 3 formed on the touch sensor member 11a is black when viewed from the touch operation surface member 12 side. In the present embodiment, the sensor circuit wiring side of the touch sensor member 11a is bonded to the touch operation surface member 12.

In addition, the touch sensor member 11b is formed on the touch sensor member 11a. The touch sensor member 11b is bonded to the touch sensor member 11a via a transparent optical adhesive film and the like (not shown). As described above, the sensor circuit wiring 3 formed on the touch sensor member 11b is black when viewed from the touch operation surface member 12 side. In the present embodiment, the sensor circuit wiring side of the touch sensor member 11b is bonded to the touch sensor member 11a. Accordingly, when a touch sensor 21 is viewed from the touch operation surface member 12 side, the sensor circuit wiring 3 is black. Therefore, when the touch sensor 21 according to the present embodiment is used for a display panel unit, the contrast of the screen is improved. In addition, it is possible to prevent a situation where the electrode is visually recognized by the operator and the occurrence of the phenomena such as black floating of the image. Therefore, the visibility of the screen can be improved.

Incidentally, the thick wire 3x in the sensor circuit wiring 3a, 3b, 3c of the touch sensor member 11a extends in the vertical direction in FIG. 7, and the thick wire 3x in the sensor circuit wirings 3a, 3b, 3c of the touch sensor member 11b extends in the horizontal direction in FIG. 7. In addition, the touch sensor 21 is configured to a concave shape on the touch operation surface member 12 side.

Hereinafter, a method of using the touch sensor 21 according to the above configuration and the operation thereof will be described.

When the finger of the operator touches the touch operation surface member 12, the touch sensor 21 according to the present embodiment can detect the touch position (contact point) thereof by the sensor circuit wiring 3 of the touch sensor member 11a and the sensor circuit wiring 3 of the touch sensor member 11b. By processing the signal with the CPU, the touch operation by the operator is recognized.

Incidentally, in the above embodiment, when the touch sensor 21 is viewed from the touch operation surface member 12 side, the color of the sensor circuit wiring 3 is not particularly limited, but in order to improve the visibility, it is preferably black.

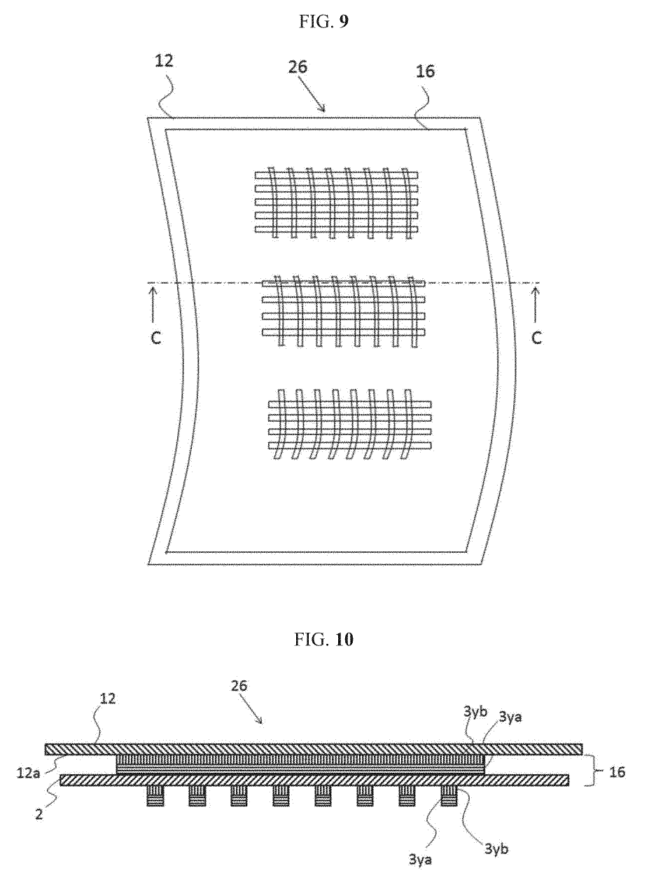

FIG. 9 is a cross-sectional view of a touch sensor 26 according to the second embodiment. The same parts as those of the first embodiment described above will not be described.

The touch sensor 26 is used as a touch panel, and includes as main components the touch sensor member 16 of the third embodiment and the touch operation surface member 12.

As shown in FIG. 10, the touch sensor member 16 is formed on one main surface 12a of the touch operation surface member 12. Incidentally, in FIG. 9, the touch operation surface member 12 is disposed on a front side when viewed on a paper, and the touch sensor member 16 is disposed on the back side when viewed on a paper. The touch sensor member 16 is bonded to the touch operation surface member 12 via a transparent optical adhesive film and the like (not shown). As described above, the sensor circuit wiring 3 formed on the touch sensor member 16 is black when viewed from the touch operation surface member 12 side. Since the thick wire 3x is formed on both sides of the base material 2 of the touch sensor member 16, the touch sensor 26 can be configured by one touch sensor member 16.

(Display Panel Unit)

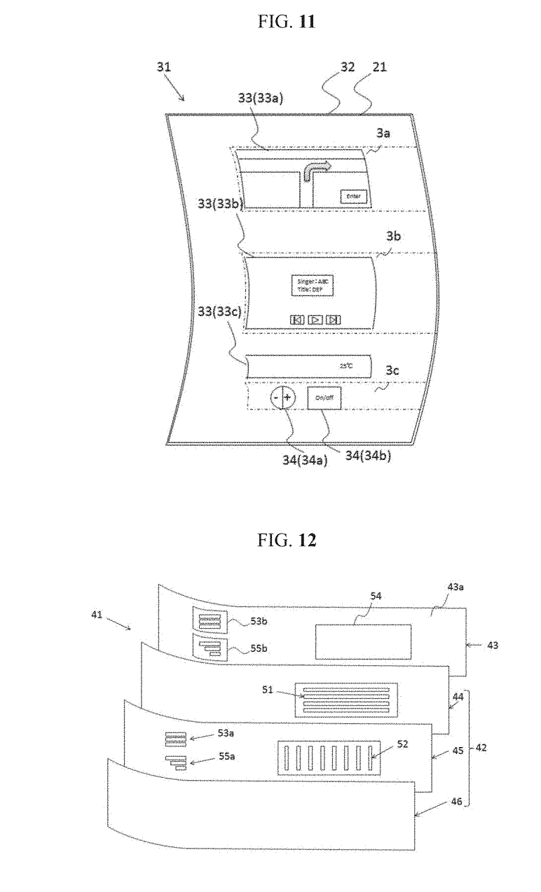

FIG. 11 is a perspective view of a display panel unit 31 according to the first embodiment of the present invention.

The display panel unit 31 includes as main components the touch sensor 21 of the first embodiment and a display plate 32. Incidentally, in FIG. 11, for the sake of simplicity, the formation region of the sensor circuit wiring 3 is indicated by a dashed line, and the sensor circuit wiring 3 is omitted.

The display plate 32 includes a base member, three display devices 33 (33a, 33b, 33c) mounted with the base member, and two switches 34 (34a, 34b). The display device 33 is a device for displaying an arbitrary video. Examples of the display device 33 include an organic EL display device, a liquid crystal display device, electronic paper, a fluorescent display tube, and the like. The organic EL display device is preferable since the image is clear, power consumption is low, and the display surface is easily formed on a curved surface. For example, as shown in FIG. 11, the switch 34 includes a switch (34a) for increasing/decreasing (−) the setting value (+), and a switch (34b) for turning on/off the power supply. For example, the switch 34 includes a light emitting device for illuminating the positions of the switch and characters such that the positions of the switches and letters emerge.

The touch sensor 21 and the display plate 32 are stacked, and are bonded via a transparent optical adhesive film and the like (not shown). As shown in FIG. 11, the sizes of the touch sensor 21 and the display plate 32 are substantially the same. In FIG. 11, there is the touch sensor 21 in the front side when viewed on the page, and there is the display plate 32 in the back side when viewed on the paper. A touch operation surface member 12 of the touch sensor 21 is disposed on the forefront side when viewed on the paper. That is, the display plate 32 including the display device 33 and the switch 34 is disposed on the opposite side of the touch operation surface member 12. Then, the operator operates the display panel unit 31 by touching the touch operation surface member 12.

As shown in FIG. 11, two display devices 33a and 33b on the upward direction are disposed so as to overlap the sensor circuit wirings 3a and 3b in a plan view. The two switches 34a and 34b are disposed in the region of the sensor circuit wiring 3c in a plan view.

Incidentally, in the first embodiment, the uppermost display device 33a is a navigation device, a display device 33 thereunder is an audio device, and a display device 33 thereunder is an air conditioner device. A touch panel is provided with a sensor circuit wiring of the touch sensor 21 on any one of the display devices 33. Further, the two switches 34a and 34b are switches for operating the air conditioner. These switches are touch switches having a sensor circuit wiring of the touch sensor 21 on the light emitting device.

Then, the display panel unit 31 is connected to the CPU via the sensor circuit wiring 3 and the lead wire 4. According to the videos and images displayed on the display devices 33a, 33b, the operator touches the portions corresponding to the display devices 33a, 33b on the touch operation surface member 12, and then the navigation device and the audio device can be operated. In addition, the operator touches a portion corresponding to the switches 34a, 34b on the touch operation surface member 12, whereby the air conditioner device can be operated. Furthermore, since the display panel unit 31 is configured such that the side of the touch operation surface member 12 has a concave shape, visibility, operability and designability are excellent.

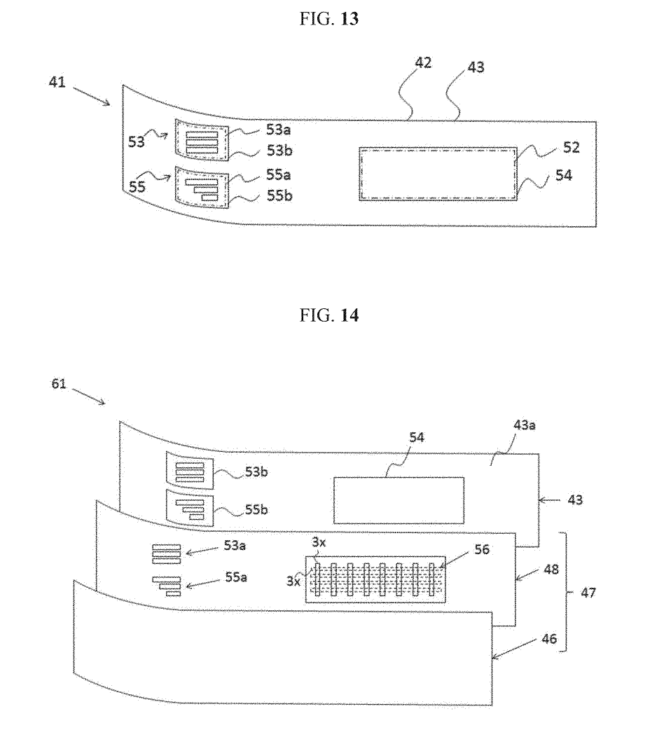

FIGS. 12 and 13 show a display panel unit 41 according to the second embodiment of the present invention.

The display panel unit 41 mainly includes a touch sensor 42 and a display plate 43.

The touch sensor 42 mainly includes two touch sensor members 44, 45 and a touch operation surface member 46. Incidentally, in FIG. 12, the lead wire is omitted for the sake of simplicity.

In the touch sensor member 44, a sensor circuit wiring 51 is formed on a glass film having a thickness of 100 μm. Incidentally, the configuration of the sensor circuit wiring 51 is the same as that of the touch sensor member 1 according to the first embodiment. In the embodiment, the thin wire 3y has a width of 8 μm and a thickness of 2 μm.

In the touch sensor member 45, sensor circuit wirings 52, 53a, 53b are formed on a glass film having a thickness of 100 μm.

Further, the touch operation surface member 46 includes a glass film having a thickness of 100 μm and is substantially the same shape and size as the touch sensor member 45. A touch sensor member 45 is stacked on the touch operation surface member 46, and the touch sensor member 44 is stacked on the touch sensor member 45. The sensor circuit wiring 51 and the sensor circuit wiring 52 are disposed such that the formation region of the sensor circuit wiring 51 and the formation region of the sensor circuit wiring 52 overlap each other.

The display plate 43 includes a display device 54 mounted on a base member 43a and light emitting devices 53b, 55b. The display device 54 is, for example, a liquid crystal display device. As shown in FIG. 12, the light emitting devices 53b, 55b are provided on a curved surface portion of the display plate 43. A touch sensor 42 is stacked on the display plate 43. Incidentally, the display plate 43 is stacked so as to be in contact with the touch sensor member 44 side of the touch sensor 42. In addition, the display device 54 is disposed so as to overlap the formation region of the sensor circuit wiring 51 and the formation region of the sensor circuit wiring 52. Further, the light emitting devices 53b, 55b are disposed so as to overlap the formation regions of the sensor circuit wirings 53a, 55a, respectively. The touch switches 53, 55 include a touch operation surface member 46, sensor circuit wirings 53a, 55a, light emitting devices 53b, 55b, a control device (not shown), and the like.

Further, as shown in FIG. 13, in the display panel unit 41, in accordance with the video and the image displayed on the display device 54, the operator can operate the device by touching a portion corresponding to the display device 54 on the touch sensor 42 (the touch operation surface member 46). In addition, the operator touches a portion corresponding to the switches 53a, 53b on the touch operation surface member 46, and then the device can be operated. In addition, the display panel unit 41 is configured such that the side of the touch operation surface member 46 is convex in the formation region of the touch switch sensor circuit wiring 53a, 55a. Incidentally, in FIG. 13, the regions where the sensor circuit wirings 52, 53a, 53b are formed are indicated by dashed lines for convenience.

FIG. 14 shows a display panel unit 61 according to a third embodiment of the present invention. The same parts as those of the second embodiment described above will not be described.

The display panel unit 61 includes as main components a touch sensor 47 and the display plate 43.

The touch sensor 47 includes as main components one touch sensor member 48 and the touch operation surface member 46.

In the touch sensor member 47, sensor circuit wirings 53a, 53b, 56 are formed on a glass film having a thickness of 100 μm. As shown in FIG. 14, the sensor circuit wiring 56 has thick wires 3x formed on both sides of the touch, sensor member 47. In the touch sensor member 47, the thick wire 3x is formed on both sides of the base material, so that the display panel unit 61 can include one touch sensor member 48. In the present embodiment, the width of the thin wire 3y formed on both sides of the base material is 8 μm and the thickness thereof is 2 μm.

Incidentally, as another embodiment, in the display panel units 41, 61 according to the second and third embodiments, display devices may be provided on the positions of the light emitting devices 53b, 55b.

Furthermore, as another embodiment, vibration generating elements can be connected to touch operation surface members 12, 4b of the display panel units 31, 41, 61 according to the first to third embodiments. When the operator touches a portion corresponding to the switch in the navigation device and the audio device to operate the apparatus and the device, vibration is generated from the vibration generating element, so that it can be confirmed that the operation is performed. Since the touch operation surface member 12 of the present embodiment includes a glass film having a thickness of 300 μm or less, it is possible to reduce the electric power required to generate vibration by driving the vibration generating element and to respond to a sharp vibration change. As the vibration generating element, it is possible to select one suitable from the viewpoints of the vibration signal specification, the driving force, the element size and the like from an eccentric motor, a linear resonance actuator, a piezo actuator and the like. In addition, it is more preferable that a plurality of vibration generating elements is provided for fitting a plurality of touch operation surfaces of the display panel unit since it is possible to individually generate vibrations according to the touch operation on each touch operation surface.

### DESCRIPTION OF REFERENCE NUMERALS

1, 11, 16: Touch sensor member
2: Base material
3: Sensor circuit wiring
4: Lead wire
3y: Thin wire
21: Touch sensor
31: Display panel unit

1. A touch sensor member comprising:
a base material, and
a sensor circuit wiring formed on the base material,
wherein the base material includes a glass film having a thickness of 300 μm or less, and
wherein the sensor circuit wiring includes a metal wire having a width of 25 μm or less.

2. The touch sensor member according to claim 1, comprising:
a substantially rectangular base material, and
a plurality of sensor circuit wirings formed on the base material,
wherein the plurality of sensor circuit wirings are formed on a plurality of regions separated from each other on the base material, and
wherein a non-formation region of the sensor circuit wiring is formed in s strip shape across an entire length in a transverse direction or a longitudinal direction of the base material.

3. A touch sensor comprising:
a touch sensor member according to claim 1, and
a touch operation surface member provided so as to cover the touch sensor member,
wherein the touch operation surface member includes a glass film having a thickness of 300 μm or less.

4. The touch sensor according to claim 3, wherein
the sensor circuit wiring is black on a touch operation surface member side.

5. A display panel unit, in which a touch sensor according to claim 3 is included and the sensor circuit wiring is a circuit wiring for a touch panel, comprising:
a display device positioned in a corresponding position of the circuit wiring for the touch panel and on an opposite side of the touch operation surface member.

6. The display panel unit according to claim 5, in which a plurality of sensor circuit wirings are included and a sensor circuit wiring different from the touch panel circuit wiring is a circuit wiring for a touch switch, comprising:
a light emitting element positioned in a corresponding position of the circuit wiring for the touch switch and on an opposite side with respect to the touch operation surface member.

7. The display panel unit according to claim 6, wherein
the touch sensor including the circuit wiring for the touch switch is formed into a curved shape.

8. A touch sensor comprising:
a touch sensor member according to claim 2, and
a touch operation surface member provided so as to cover the touch sensor member,
wherein the touch operation surface member includes a glass film having a thickness of 300 μm or less.

9. The touch sensor according to claim 8, wherein
the sensor circuit wiring is black on a touch operation surface member side.

10. A display panel unit, in which a touch sensor according to claim 8 is included and the sensor circuit wiring is a circuit wiring for a touch panel, comprising:
a display device positioned in a corresponding position of the circuit wiring for the touch panel and on an opposite side of the touch operation surface member.

11. The display panel unit according to claim 10, in which a plurality of sensor circuit wirings are included and a sensor circuit wiring different from the touch panel circuit wiring is a circuit wiring for a touch switch, comprising:
a light emitting element positioned in a corresponding position of the circuit wiring for the touch switch and on an opposite side with respect to the touch operation surface member.

12. The display panel unit according to claim 11, wherein
the touch sensor including the circuit wiring for the touch switch is formed into a curved shape.
